(19) United States
(12) Patent Application Publication
(10) Pub. No.: US 2009/0276525 A1
(43) Pub. Date: Nov. 5, 2009

(54) METHOD AND APPARATUS FOR INTEGRATING HETEROGENEOUS SENSOR DATA IN UBIQUITOUS SENSOR NETWORK

(76) Inventors: Jung Hee Jo, Daejeon (KR); Kwang Soo Kim, Daejeon (KR); Yong Joon Lee, Daejeon (KR); Jong-Hyun Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/515,366

(22) PCT Filed: Sep. 7, 2007
(86) PCT No.: PCT/KR07/04331

§ 371 Date: May 18, 2009

(30) Foreign Application Priority Data
Dec. 5, 2006 (KR) 10-2006-0122113
Apr. 17, 2007 (KR) 10-2007-0037384

(51) Int. Cl. G06F 15/16; G06F 7/00; G06F 17/30; G06F 15/173

(52) U.S. Cl. 709/224; 707/2; 707/102; 709/223; 707/E17.014; 707/E17.044

(57) ABSTRACT

Provided is an apparatus and method for integrating heterogeneous sensor data in a ubiquitous sensor network. The method includes steps of receiving an integrated query for heterogeneous sensor networks from a sensor network management system, disintegrating the received integrated query to be suitable for each sensor network and transmitting the disintegrated queries to each corresponding sensor network. The method further includes steps of generating responses as integrated sensor data and storing the integrated sensor data into an integrated database, when receiving responses to respective queries from each of the sensor networks, and converting the integrated sensor data stored in the integrated database into a preset data format and transmitting the converted sensor data to the sensor network management system.

### TECHNICAL FIELD

The present invention relates to a remote sensor networking technology in a Ubiquitous Sensor Network (hereinafter, referred to as “USN”) environment, and more particularly, to a method and apparatus that integrates heterogeneous sensor data suitable to the integration of heterogeneous sensor data in a ubiquitous sensor network.

### BACKGROUND ART

One of the most significant issues in a USN environment is the integration of heterogeneous sensor data. The integration of heterogeneous sensor data is normally implemented by a USN middleware. A conventional method for providing an application service, such as an unmanned guard service, a fire alarm service or the like by using a USN middleware has been proposed. However, a detailed method for integrating heterogeneous sensor data by a middleware has not been proposed.

That is because the necessity to integrate heterogeneous sensor data was not proposed since a conventional art adopted a same kind of sensors for aiming at a single application in a single domain. However, an issue of integrating heterogeneous sensor data has been presented because a technology advance lead to a use of various types of sensors and a coverage range of one sensor network became wider from a single application to plural applications.

This tendency affected users who normally use the application. However, in general, they are only experts in a corresponding application not in a complicated operating procedure in a sensor network. Therefore, the issue could be greatly notified in a USN environment including a diversity of sensor networks, but a specific solution to this has not been provided.

### DISCLOSURE OF INVENTION

### Technical Problem

It is, therefore, a primary object of the present invention to provide a method and apparatus for integrating heterogeneous sensor data in a heterogeneous ubiquitous sensor network environment in which a plurality of different sensor networks and sensor network management systems operate in a plurality of domains.

It is another object of the present invention to provide a method and apparatus for integrating heterogeneous sensor data in a ubiquitous sensor network capable of receiving sensor data from gateways each connecting different sensor networks in a plurality of domains by a middleware, integrating the received sensor data and transmitting the integrated data to a sensor network management system, and inquiring or querying data on sensor nodes located in a plurality of domains in the sensor network management system.

It is still another object of the present invention to provide a method and apparatus for integrating heterogeneous sensor data in a ubiquitous sensor network capable of separating the integrated query to be suitable for each sensor network on a middleware, which is transferred from a sensor network management system connecting with different sensor networks in a plurality of domains and integrating responses which were sent to the middle ware from the each sensor network as responses to the respective queries of the sensor network management system and transferring the integrated response to the sensor network.

### Technical Solution

In accordance with an embodiment of the present invention, there is provided a method for integrating heterogeneous sensor data in a ubiquitous sensor network. The method includes steps of: receiving an integrated query for heterogeneous sensor networks from a sensor network management system; disintegrating the received integrated query into each of queries to be suitable for each sensor network; transmitting the disintegrated queries to each corresponding sensor network, generating and storing integrated sensor data into an integrated database, upon receiving responses to the respective queries from each of the sensor networks; and converting the integrated sensor data stored in the integrated database into a preset data format and transmitting the converted sensor data to the sensor network management system.

In accordance with another embodiment of the present invention, there is provided an apparatus for integrating heterogeneous sensor data in a ubiquitous sensor network. The apparatus includes a sensor data provider for receiving an integrated query by accessing to a sensor network management system, and transmitting integrated sensor data as responses to the respective queries, to the sensor network management system; a data manager for disintegrating the integrated query to be proper to each sensor network and transmitting the disintegrated queries; and converting the sensor data, that is obtained by integrating responses each corresponding to sensor-network, into a preset data format and transmitting the converted sensor data to the sensor data provider; and a network adaptor for monitoring and storing information of each of sensor networks, converting the each disintegrated query into a data format standard defined depending on each sensor network, transmitting the converted queries, and receiving responses to the transmitted queries.

### ADVANTAGEOUS EFFECTS

The present invention integrates heterogeneous sensor data to meet the user's requirements for a plurality of sensor network management systems operating in a plurality of domains. Thus, the present invention has an effect of easily adding a sensor network or a sensor network management system, and enabling the user to inquire sensor values for heterogeneous sensor nodes of a plurality of sensor networks through an application program interface of the sensor network system and perform a query for a specific sensor node without knowledge about the sensor network or XML.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram illustrating an environment of a single sensor network system for accessing a single kind of sensor networks;

FIG. 2 is a diagram showing a scheme in which different sensor networks are connected with sensor network management systems every domain;

FIG. 3 is a diagram depicting a USN middleware for integrating heterogeneous sensor networks located on a plurality of domains in accordance with an embodiment of the present invention;

FIG. 4 is a diagram illustrating configuration of a USN middleware for integrating heterogeneous sensor data in accordance with an embodiment of the present invention;

FIG. 5 is a diagram presenting a schema of an integrated sensor database for integrating and storing heterogeneous sensor data in accordance with an embodiment of the present invention; and

FIG. 6 is a first part of a flowchart illustrating an operating procedure of integrating heterogeneous sensor data in response to a user's query in a USN middleware in accordance with an embodiment of the present invention.

FIG. 7 is a second part of the flowchart illustrating an operating procedure of integrating heterogeneous sensor data in response to a user's query in a USN middleware in accordance with an embodiment of the present invention.

### BEST MODE FOR CARRYING OUT THE INVENTION

Hereinafter, embodiments of the present invention will be described in detail with reference to the accompanying drawings. In the following description, detailed descriptions for well-known functions or constructions will be omitted in case where they would obscure the invention in unnecessary detail. Below terms, which are defined considering functions in the present invention, can vary depending on user and operator's intention or practice. Therefore, the terms should be defined on the basis of the disclosure throughout this specification.

The embodiment of the present invention is to integrate heterogeneous sensor data in a heterogeneous ubiquitous sensor network environment in which a plurality of applications operate in a plurality of domains. The operating sequence for integrating sensor data is: receiving sensor data sent from gateways each connecting different sensor networks in a plurality of domains by using a middleware, integrating the sensor data, and transmitting the integrated sensor data to a sensor network management system; and inquiring or querying data of sensor nodes located in a plurality of domains in the sensor network management system.

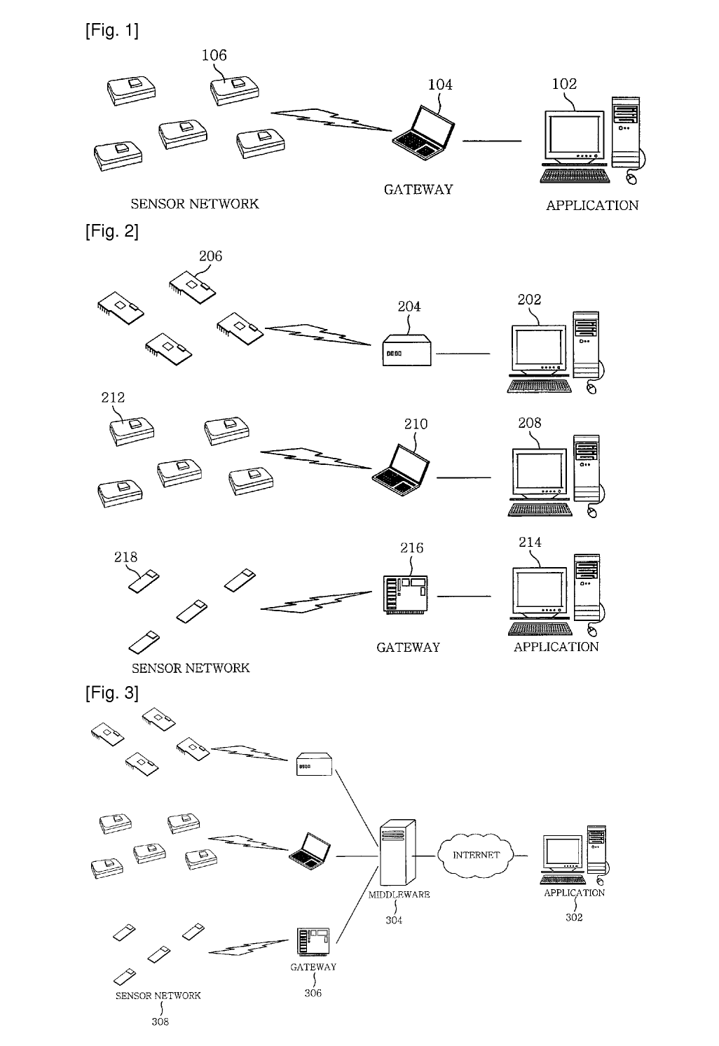

FIG. 1 is a diagram illustrating an environment of a single sensor network system for accessing a single kind of sensor networks.

Referring to FIG. 1, the sensor network management system 102 can access a single kind of sensor networks located in the same domain via a gateway 104. Thus, a user requests for specific sensor information to a sensor network 106 by using an application program of the sensor network management system 102. The, the sensor network 106 generates sensor information in response to the request by performing a survey for the requested part and transmits the generated sensor information to the sensor network management system 102 via the gateway 104.

FIG. 2 is a diagram depicting a scheme in which different sensor networks are connected with sensor network management systems depending on each domain.

Referring to FIG. 2, there are different heterogeneous sensor networks 206, 212, and 218 in domains in an environment without a function for integrating heterogeneous sensor data. In order to access the different sensor networks 206, 212, and 218, the sensor network management systems 202, 208, 214 having the same function corresponding to each of the sensor networks 206, 212 and 218 should be redundantly installed.

In a heterogeneous ubiquitous sensor network environment in which a plurality of sensor networks and sensor network management systems operate in a multiplicity of domains as shown in FIG. 1 or 2, without the integration of heterogeneous sensor data, sensor network management systems having a same function corresponding to each sensor network are needed, thereby causing a redundancy of a design of the sensor network management system. Further, when a sensor network management system accesses a multiplicity of sensor networks, a method for searching a specific sensor network requested by a user.

FIG. 3 is a diagram illustrating a USN middleware for integrating heterogeneous sensor networks located on a plurality of domains in accordance with an embodiment of the present invention.

Referring to FIG. 3, a single USN middleware 304 integrally controls gateways 306 connected to heterogeneous sensor networks 308 each having different function depending on each domain. By using the USN middleware 304 as a controller, it is not required to modify a sensor network management system 302 connected with the USN middleware 304 over the Internet and it is possible for the single sensor network management system 302 to access to each of the different sensor networks 308 and refer to sensor data corresponding thereto.

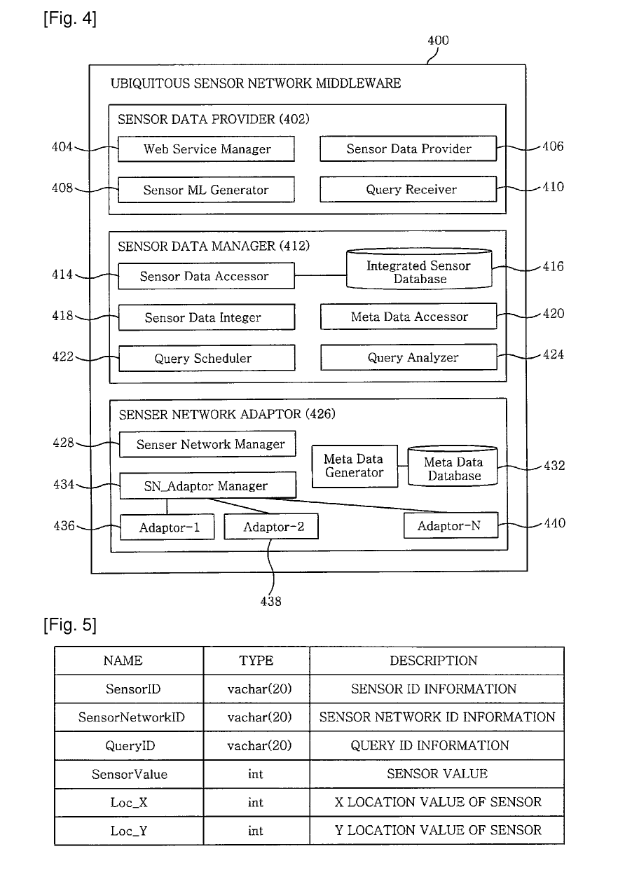

FIG. 4 is a diagram showing a configuration of a USN middleware for integrating heterogeneous sensor data in accordance with an embodiment of the present invention.

Referring to FIG. 4, the USN middleware 400 includes a sensor data provider 402, a sensor data manager 412, and a sensor network adapter 426. The sensor data provider 402 transfers sensor data sent from sensor nodes of a sensor network to a sensor network management system. The sensor data provider 402 includes a web service manager 404, a sensor data provider 406, a sensorML generator 408, and a query receiver 410. The web service manager 404 accesses an application program of the sensor network management system by using a web service. The sensor data provider 406 provides sensor data to the sensor network management system. The sensorML generator 408 converts sensor data into eXtensible Markup Language (XML) and provides the XML data to the sensor network management system. The query receiver 410 receives queries from the sensor network management system.

The sensor data manager 412 integrates and stores sensor data. The sensor data manager 412 includes a sensor data accessor 414, an integrated sensor database 416, a sensor data integrator 418, a meta data accessor 420, a query scheduler 422, and a query analyzer 424. The sensor data integrator 418 disintegrates an integrated query generated by the sensor network management system for heterogeneous sensor networks to be suitable for the each sensor network, integrates responses to queries each received from the sensor networks, and provides the integrated response to the sensor network management system. The sensor data accessor 414 accesses information on integrated sensor data. The integrated sensor database 416 stores sensor data that is an integrated data of diverse information of each sensor network (a sensor network ID, a sensor ID and the like), a query ID, and responses to the respective query. The meta data accessor 420 refers meta information on each sensor network for query processing. The query scheduler 422 schedules each query depending on each heterogeneous sensor network. The query analyzer 424 analyzes a query received from an application program of the sensor network management system.

The sensor network adaptor 426 has a function to abstract the middleware 400 from heterogeneous sensor networks. That is, sensor network adaptor 426 generates meta information by monitoring a type and a current state of a sensor belonging to each heterogeneous sensor network, distributes and transmits queries from the sensor network management system by referring to a communication protocol defined by a heterogeneous sensor network for the purpose of obtaining data from the heterogeneous sensor network by accessing thereto. The sensor network adaptor 426 includes a sensor data manager 428, a meta data generator 430, a meta data database 432, adaptors 436, 438, and 440, and an SN_Adaptor manager 434. The sensor data manager 428 manages sensor data received from the sensor networks. The meta data generator 430 generates meta data by continuously monitoring information on each sensor and sensor network. The meta data database 432 stores information generated by the meta data generator 430. The adaptors 436, 438, and 440 each access sensor networks and process works dependent on the sensor networks. The SN_Adaptor manager 434 manages the adaptors 436, 438, and 440, respectively.

FIG. 5 is a diagram illustrating a schema of an integrated sensor database for integrating and storing heterogeneous sensor data in accordance with an embodiment of the present invention.

Referring to FIG. 5, the schema of integrated sensor database is designed for integrating and managing the sensor data on a middleware. The database includes sensor ID information, sensor network ID information, a query ID for referring to a sensor value, sensor data (i.e., a responses to respective queries) and X and Y location values of each sensor. The sensor ID information, the sensor network ID information, and the sensor X and Y location values can be generated on the basis of the metadata database. The query ID can be generated from a request message of an integrated query.

In other words, integrated sensor data is generated by including data in such a schema. Identification of each location for a sensor and a sensor network, a transmission/reception of proper information depending on sensors, a variation of queries and query-dependent sensor values, and execution state can be detected through the database schema.

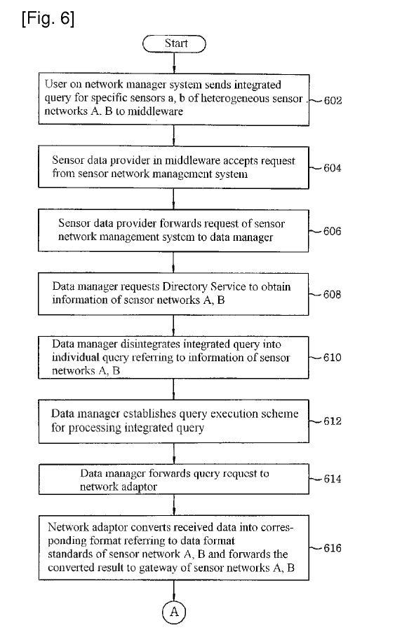

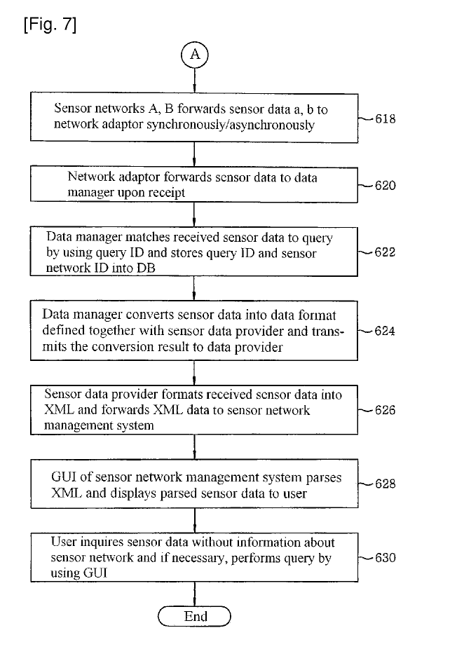

FIGS. 6 and 7 present together a flowchart illustrating an operating procedure of integrating heterogeneous sensor data in response to a user's query in a USN middleware in accordance with an embodiment of the present invention.

FIGS. 6 and 7 show a procedure of processing sensor data on a user's query in the USN middleware integrating a plurality of sensor networks. In step 602, a user in a sensor network management system transmits an integrated query that is a request for queries for specific sensors a, b of heterogeneous sensor networks A, B to the middleware over the Internet. In step 604, a data provider in the middleware accepts the request from the sensor network management system. In step 606, a sensor data provider forwards a request message of an integrated query received from the sensor network management system to a data manager.

In step 608, the data manager accesses a metadata database (e.g., a directory service) to obtain information of the sensor networks A, B therefrom. In step 610, the data manager disintegrates the integrated query into individual queries for each of sensor networks by referring to information on the sensor networks A, B received from the metadata database.

The data manager establishes a query execution scheme for processing the disintegrated queries in step 612 and forwards a request message of a query to a network adaptor in step 614. Thus, the network adaptor converts data into a corresponding format by referring to data format standards of the sensor networks A, B, and then forwards the converted data to gateways connecting with the sensor networks A, B.

In step 618, the sensor networks A, B generate sensor data a, b on the request message of a query and forwards the sensor data a, b to the network adaptor synchronously or asynchronously. In step 620, upon receiving the sensor data a, b, the network adaptor forwards the sensor data a, b to the data manager. In step 622, the data manager matches sensor data a, b received by using the query ID to query, stores integrated sensor data obtained by integrating a query ID, sensor network ID and the like, into an integrated sensor database. In step 624, the data manager converts the integrated sensor data into a data format that is preset together with the sensor data provider and then, transmits the converted sensor data to the sensor data provider.

In step 626, the sensor data provider formats the sensor data a, b among the received integrated sensor data into an XML and transmits the formatted sensor data a, b to the sensor network management system through an Internet web service. In step 628, an application program of the sensor network management system parses the received XML sensor data a, b and outputs to display the parsed sensor data a, b for a user.

In step 630, the user can inquire the queried sensor data a, b. Subsequently, the user stores a given query by using an application program or performs additional queries. As described above, the present invention integrates heterogeneous sensor data by a middleware in a heterogeneous USN environment in which a plurality of sensor network management systems operate in a plurality of domains, thereby enabling efficient interworking between heterogeneous sensors and services and, further enabling a user using an application program of the sensor network management system to set a sensor network to be accessed from an in-service application in real-time and perform distribution queries for diverse sensor networks.

1. A method for integrating heterogeneous sensor data in a ubiquitous sensor network, the method comprising:
receiving an integrated query for heterogeneous sensor networks from a sensor network management system;
disintegrating the received integrated query into each of queries to be suitable for each sensor network;
transmitting the disintegrated queries to each corresponding sensor network;
generating and storing integrated sensor data into an integrated database, upon receiving responses to the respective queries from each of the sensor networks; and
converting the integrated sensor data stored in the integrated database into a preset data format and transmitting the converted sensor data to the sensor network management system.

2. The method of claim 1, further comprising:
generating meta information by continuously monitoring information on the sensor networks;
storing the generated meta information into a meta information database;
identifying the meta information on the per-sensor-network basis;
transmitting the disintegrated queries based on the identified meta information corresponding to each of the sensor networks.

3. The method of claim 2, wherein the step of transmitting the disintegrated queries to each corresponding sensor network includes transmitting the converted query after converting the each disintegrated query into a corresponding format with reference to data format standards defined according to each of sensor networks.

4. The method of claim 1, wherein the integrated sensor data includes sensor identification information, sensor network information, sensor location information, query information, and sensor data as response information to a query.

5. An apparatus for integrating heterogeneous sensor data in a ubiquitous sensor network, the apparatus comprising:
a sensor data provider for receiving an integrated query by accessing to a sensor network management system, and transmitting integrated sensor data as responses to the respective queries, to the sensor network management system;
a data manager for disintegrating the integrated query to be proper to each sensor network and transmitting the disintegrated queries; and converting the sensor data, that is obtained by integrating responses each corresponding to sensor-network, into a preset data format and transmitting the converted sensor data to the sensor data provider; and
a network adaptor for monitoring and storing information of each of sensor networks, converting the each disintegrated query into a data format standard defined depending on each sensor network, transmitting the converted queries, and receiving responses to the transmitted queries.

6. An apparatus of claim 5, wherein the sensor data provider includes:
a service manager for accessing the sensor network management system;
a sensor-format generator for converting sensor data into a preset format; and
a query receiver for receiving an integrated query from the sensor network management system.

7. The apparatus of claim 5, wherein the data manager includes:
a sensor data integrator for disintegrating the integrated query to be proper to each sensor network and integrating responses to queries received from the respective sensor networks;
an integrated sensor database for storing integrated sensor data forwarded from the sensor data integrator;
a data accessor for referring to information of the integrated sensor data;
a meta data accessor for identifying meta information of each of the sensor networks;
a query scheduler for scheduling queries for respective sensor networks; and
a query analyzer for analyzing the queries.

8. The apparatus of claim 5, wherein the network adaptor includes:
a sensor data manager for managing sensor data received from the sensor networks;
a meta data generator for generating meta data by continuously monitoring the information of the sensor network;
a meta data database for storing information generated from the meta data generator;
an adaptor for accessing each of the sensor networks; and
an adaptor manager for managing the adaptor.

9. The apparatus of claim 5, wherein the integrated sensor data includes sensor identification information, sensor network information, sensor location information, query information, and sensor data as response information to a query.
